(19) United States
(12) Patent Application Publication
(10) Pub. No.: US 2002/0057453 A1
(43) Pub. Date: May 16, 2002

(54) Methods and apparatus for adjusting cover printing based on book caliper

(76) Inventors: A. John Michaelis, Balmain (AU); James L. Warmus, LaGrange, IL (US); Did-Bun Wong, Glen Ellyn, IL (US)

Correspondence Address: MARSHALL, O'TOOLE, GERSTEIN, MURRAY & BORUN, 6300 SEARS TOWER, 233 SOUTH WACKER DRIVE, CHICAGO, IL, 60606-6402, US

(21) Appl. No.: 09/933,305

(22) Filed: Aug. 20, 2001

Related U.S. Application Data
(60) Provisional application No. 60/226,745, filed on Aug. 21, 2000.

(51) Int. Cl. G06F 15/00

(52) U.S. Cl. 358/1.15

(57) ABSTRACT

The methods and apparatus described herein provide a system for adjusting book cover printing based on the caliper of the book. The caliper of a particular printed book body is measured. Subsequently, a cover is printed for that particular printed book. Printing on the cover is adjusted to compensate for slight variations in the thickness of the book body. For example, a book title which is to be centered on the spine may be transposed if a non-nominal spine size is used to accommodate a non-nominal book body (i.e., a book body which is larger or smaller than the average size for this book).

### RELATED APPLICATION

This application claims priority from U.S. Provisional Application Ser. No. 60/226,745 filed Aug. 21, 2000, and which is hereby incorporated herein by reference.

### TECHNICAL FIELD

The present system relates in general to digital printing, and, in particular, to methods and apparatus for adjusting cover printing based on book caliper.

### BACKGROUND

Book binding applications have the problem that the caliper (i.e., thickness) of the book varies from book to book (even with books of the same number of pages). The causes of these variations include: variations in paper thickness from paper batch to paper batch (even for the identical paper specification) variations in humidity, variations in the amount of ink or toner printed on the page, variations in the pressure applied to the paper in the print process, the bind process and possibly the calendaring processes.

Variations in the thickness of the book cause artwork (including text) printed on the cover of the book to shift slightly from book to book. For example, an image intended for the center of a book will shift slightly to the left if more than an average amount of cover material is taken up by the binding of the book (i.e., if the book is thicker than normal). Similarly, cover art will shift slightly to the right if less than an average amount of cover material is taken up by the binding of the book (i.e., if the book is thinner than normal).

### BRIEF DESCRIPTION OF THE DRAWINGS

Features and advantages of the disclosed methods and apparatus will be apparent to those of ordinary skill in the art in view of the detailed description of exemplary embodiments which is made with reference to the drawings, a brief description of which is provided below.

FIG. 1 is a high level block diagram of a printing system.

FIG. 2 is a more detailed block diagram of the cover print head controller illustrated in FIG. 1.

FIG. 3 is an exemplary printed cover.

FIG. 5 is a flowchart of a process for adjusting cover printing based on book caliper.

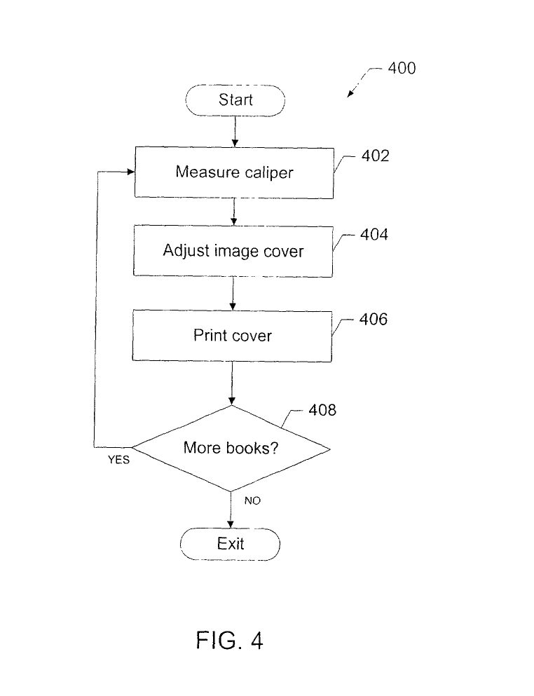

### DETAILED DESCRIPTION OF THE PREFERRED EMBODIMENTS

In general, the system described herein adjusts cover printing based on book caliper. The caliper of a particular printed book body is measured. Subsequently, a cover is printed for that particular printed book. Printing on the cover is adjusted to compensate for slight variations in the thickness of the book body. For example, a book title which is to be centered on the spine may be transposed if a non-nominal spine size is used to accommodate a non-nominal book body (i.e., a book body which is larger or smaller than the average size for this book).

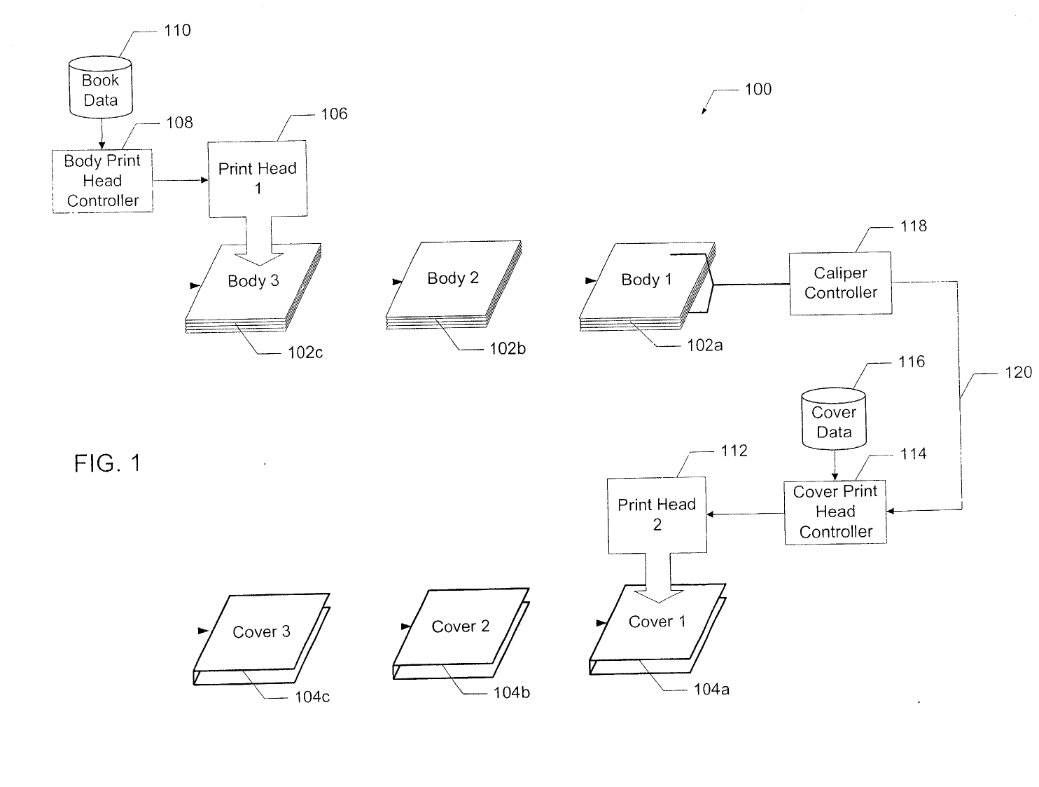

A high level block diagram of a printing system 100 providing a preferred environment of use is illustrated in FIG. 1. The system 100 prints a plurality of book bodies 102 and a plurality of corresponding book covers 104. The book bodies 102 may be printed separate from the corresponding book covers 104 as shown, or the book bodies 102 and the book covers 104 may be printed using the same process. In the event that the book bodies 102 are printed separate from the corresponding book covers 104, a bar code label or other tracking mechanism may be used to match a particular book body 102 to a particular book cover 104.

The book bodies 102 are printed using a print head 106. The print head 106 is preferably part of a well known digital printing system such as a digital press (e.g., a Xeikon DCP-1 digital press). The print head 106 is controlled by a print head controller 108. The print head controller 108 typically includes a microprocessor and program memory adapted to receive digital data 110 representing the text and/or images associated with a particular book (or other publication). This book data 110 is preferably stored in a computer readable memory in a well known manner. The print head controller 108 preferably converts the book data 110 into printing commands for the print head 106 in a well known manner.

Similarly, each book cover 104 is preferably printed using a print head 112 which is connected to a digital printing system. As discussed above, this print head 112 may be the same print head 106 used to produce book bodies 102. The cover print head 112 is also controlled by a print head controller 114. This print head controller 114 may be the same print head controller 108 used to produce book bodies 102. As with the body print head controller 108, the cover print head controller 114 typically includes a microprocessor and program memory adapted to receive digital data 116 representing the text and/or images associated with a particular book cover. Again, this cover data 116 is preferably stored in a computer readable memory, and the print head controller 114 preferably converts the cover data 116 into printing commands for the print head 112 in a well known manner.

The cover print head controller 114 also receives a thickness measurement from a caliper controller 118 via a communication line or network 120. The caliper controller 114 measures the thickness of each book body 102 after the book body is produced. The cover print head controller 114 may then adjust the printing commands sent to the print head 112 to compensate for variations in book body thickness.

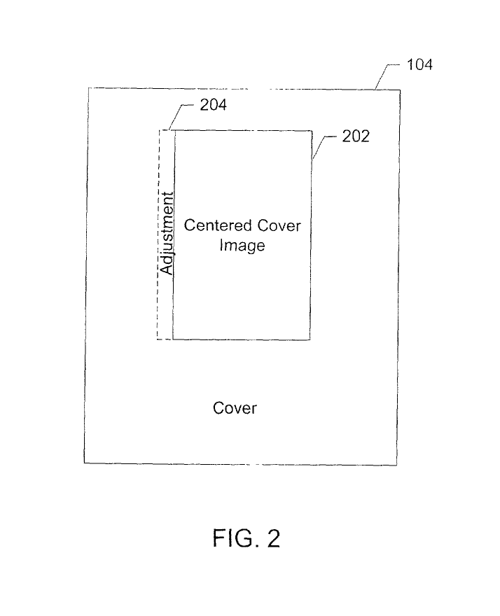

Referring to the example cover 104 illustrated in FIG. 2, if the cover data 116 represents an image which is intended to be centered on the cover of the book 104, thicker books tend to “move” the cover image toward the spine of the book, because more spine is used to accommodate the thickness of the book. Conversely, thinner books tend to “move” the cover image away from the spine of the book, because less spine is used to accommodate the thickness of the book. Similarly, if the spine of the book is being printed, thicker than normal spines tend to move the spine printing to the left, and thinner than normal spines tend to move the spine printing to the right.

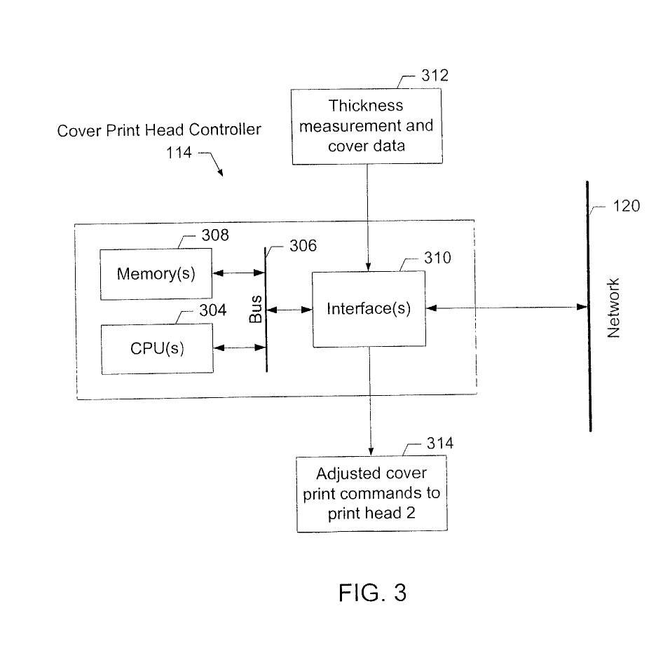

A more detailed block diagram of the cover print head controller 114 is illustrated in FIG. 3. The print head controller 114 preferably includes a central processing unit 304 electrically coupled by an address/data bus 306 to a memory device 308 and a network interface circuit 310. The CPU 304 may be any type of well known CPU, such as an Intel PentiumTM processor. The memory device 308 preferably includes volatile memory, such as a random-access memory (RAM), and non-volatile memory, such as a read only memory (ROM) and/or a magnetic disk. The memory device 308 stores a software program that may implement all or part of the method described below. This program is executed by the CPU 304, as is well known. However, some of the steps described in the method below may be performed manually or without the use of the print head controller 114. The memory device 308 also stores data, files, programs, etc.

The print head controller 114 may exchange data with other computing devices via a connection to the network 120. The network interface circuit 310 may be implemented using any data transceiver, such as an Ethernet transceiver. The network 120 may be any type of network, such as a local area network (LAN) and/or the Internet. Of course, a person of ordinary skill in the art will readily appreciate that a direct communications connection may be substituted for a network connection.

A flowchart of a process 400 for adjusting cover printing based on book caliper is illustrated in FIG. 4. Preferably, the process 400 is executed by the print head controller CPU 304 in a well known manner. However, one or more of the steps described below may be performed in conjunction with another device, a user, and/or without the use of a CPU. Generally, the process 400 adjusts book cover printing based on the caliper of the book.

The process 400 begins by measuring the caliper of a particular book in a well known manner (step 402). Subsequently, data indicative of a cover image, print commands, and/or margin data associated with a cover image are adjusted based on the difference between the measured caliper and a prestored nominal caliper value for the particular book title (step 404). For example, a book title and/or graphic image may be shifted slightly left or right to compensate for the difference between the measured caliper and the prestored nominal caliper value. Cover images may include spine images. Once the image is adjusted, the cover is printed using a well known digital press or any other printing mechanism (step 406). If there are more book covers to be printed (step 408), the process 400 repeats. If there are no more book covers to be printed (step 408), the process 400 exits.

In an alternate embodiment, a toner bar or pattern may be printed across the entire bound edge of each printed page to equalize the caliper of the book backbone (i.e., make “thin” areas closer in thickness to “thick” areas). If there is an area of high print density on the page, that might cause an uneven caliper in the book backbone, a narrow band or pattern of toner would be printed parallel to the backbone to compensate. This pattern is preferably hidden under the cover and insures that the caliper is substantially consistent across the full length of the backbone.

In another embodiment, in-line monitoring of printing parameters may be used to anticipate the caliper of the book backbone in sizing the cover. In this implementation, measurement of individual pages, groups of pages, or the collective body of pages are made to ascertain significant variations in backbone width, and this information is then fed to a digital press control system. The control system then adjusts the imaging (e.g., postscript) of the corresponding cover by extending or reducing the backbone size appropriately.

In addition, the process may accommodate for unequal distribution across the backbone by making small angle rotations of the cover. In this embodiment, the amount of ink “stacking up” in a given area may be electronically summed based on page images. In this manner, the caliper of the book body need not be physically measured. Still further, if the ink summation process determines that there is an unequal distribution across the backbone, a partial band may be used to equalize the book thickness. In other words, a toner bar or pattern may be printed across the portions of the bound edge of one or more printed pages to equalize the caliper of the book backbone. This method uses less ink than the toner bar method described above, but requires additional steps.

In summary, persons of ordinary skill in the art will readily appreciate that a method and apparatus for adjusting cover printing based on book caliper has been provided. Systems implementing the teachings described herein can produce consistent book covers despite variations in book caliper.

The foregoing description has been presented for the purposes of illustration and description. It is not intended to be exhaustive or to limit the invention to the exemplary embodiments disclosed. Many modifications and variations are possible in light of the above teachings. It is intended that the scope of the invention be limited not by this detailed description of exemplary embodiments, but rather by the claims appended hereto.

What is claimed is:

1. A method of adjusting cover printing associated with a printed publication based on a caliper measurement of the printed publication, the method comprising the steps of:
receiving a prestored nominal caliper value;
determining a measured caliper value of the printed publication by measuring the thickens of the printed publication;
adjusting print data associated with a cover intended for the printed publication based on a difference between the measured caliper value and the prestored nominal caliper value; and
printing the cover using the adjusted print data.

2. A method as defined in claim 1, wherein the step of receiving a prestored nominal caliper value comprises the step of retrieving the prestored nominal caliper value from a networked computer readable media.

3. A method as defined in claim 1, wherein the step of adjusting print data comprises the step of adjusting cover graphics.

4. A method as defined in claim 1, wherein the step of adjusting print data comprises the step of adjusting cover text.

5. A method as defined in claim 1, wherein the step of adjusting print data comprises the step of adjusting margin data.

6. A method as defined in claim 1, wherein the step of adjusting print data comprises the step of adjusting print commands.

7. A method as defined in claim 1, wherein the step of adjusting print data associated with a cover intended for the printed publication based on a difference between the measured caliper value and the prestored nominal caliper value comprises the step of shifting a cover image by more than 40% and less than 60% of the difference between the measured caliper value and the prestored nominal caliper value.

8. A method of equalizing the caliper of a printed publication backbone, the method comprising the steps of:
determining a thick area and a thin area of the printed publication backbone, the thick area being wider than the thin area; and
placing toner on a plurality of pages in an area of the pages corresponding to the thin area.

9. A method as defined in claim 8, wherein the step of determining a thick area and a thin area of the printed publication backbone comprises the step of measuring the printed publication backbone at at least two locations.

10. A method as defined in claim 9, wherein the step of measuring the printed publication backbone occurs during the printing process.

11. A method as defined in claim 8, wherein the step of determining a thick area and a thin area of the printed publication backbone comprises the step of electronically determining ink density at a plurality of locations along the backbone based on print data used to print the printed publication.

12. A method as defined in claim 8, wherein the step of placing toner on a plurality of pages comprises the step of placing the toner in an area of the pages that will be hidden under the cover.

13. An apparatus for adjusting cover printing associated with a printed publication based on a caliper measurement of the printed publication, the apparatus comprising:
an interface circuit structured to receive the caliper measurement and transmit cover print commands;
a memory device storing a software program and a nominal caliper value; and
a processing unit operatively coupled to the interface circuit and the memory device, the processing unit being structured to execute the software program, the software program being structured to cause the processing unit to:
retrieve the nominal caliper value from the memory device;
receive the caliper measurement from the interface circuit;
adjust cover print commands based on a difference between the received caliper measurement and the retrieved nominal caliper value; and
transmit the adjusted cover print commands via the interface circuit.

14. An apparatus as defined in claim 13, wherein the software program is structured to cause the processing unit to shift a cover image by more than 40% and less than 60% of the difference between the received caliper measurement and the retrieved nominal caliper value.

15. An apparatus as defined in claim 13, wherein the software program is further structured to cause the processing unit to determine a thick area and a thin area of the printed publication backbone, the thick area being wider than the thin area; and cause ink to be printed on a plurality of pages in an area of the pages corresponding to the thin area.

16. An apparatus as defined in claim 15, wherein the software program is further structured to cause the processing unit to determine ink density at a plurality of locations along the backbone based on print data used to print the printed publication.

17. An apparatus as defined in claim 15, wherein the software program is further structured to cause the processing unit to cause ink to be placed in an area of the pages that will be hidden under a cover associated with the printed publication.
